(19) United States
(12) Patent Application Publication
(10) Pub. No.: US 2013/0176100 A1
(43) Pub. Date: Jul. 11, 2013

(54) AUTOMATED ELECTRONIC DEVICE NETWORK PAIRING BASED ON ELECTRIC FIELD COUPLING

(71) Applicant: TK Holdings Inc., Auburn Hills, MI (US)

(72) Inventors: Craig White, Grosse Pointe, MI (US); Len Cech, Brighton, MI (US)

(73) Assignee: TK Holdings Inc., Auburn Hills, MI (US)

(21) Appl. No.: 13/735,816

(22) Filed: Jan. 7, 2013

Related U.S. Application Data
(60) Provisional application No. 61/584,278, filed on Jan. 8, 2012.

(51) Int. Cl. G08C 19/00

(52) U.S. Cl. CPC G08C 19/00
USPC 340/1.1

(57) ABSTRACT

A system for controlling an electronic device includes a sensor configured to detect occupancy of a person and a sensing electrode that provides an encoded signal in response to the sensor, the signal having a particular frequency and power. The sensing electrode is configured to transmit the signal to the person detected by the sensor. The frequency of the signal provided by the sensing electrode is configured to allow the signal to be redistributed through a person easily. An electronic device is configured to detect the signal when the electronic device is coupled to the person, and a response of the electronic device to the signal is controlling a feature of the electronic device.

### CROSS-REFERENCE TO RELATED PATENT APPLICATIONS

This application claims priority to and the benefit of U.S. Provisional Application No. 61/584,278, filed Jan. 8, 2012, incorporated herein by reference in its entirety.

### BACKGROUND

The present application relates generally to a method and system used to control an electronic device in a vehicle based on information regarding an occupant of the vehicle.

The growth of electronic devices, particularly mobile communication devices (i.e., cell phones, PDAs, tablet computers, MP3 players, laptop computers, e-readers), has had a significant effect on automotive safety. Drivers who use mobile communication devices to place phone calls, read and send text messages, or read and send email messages have approximately the same chance of causing a serious accident as those who drive under the influence of drugs or alcohol. Further, each new introduction of mobile communication technology contributes to the issues relating to “distracted drivers.”

In response to these issues, many jurisdictions have enacted laws to make it illegal to operate a mobile communication device while driving. However, these laws are very difficult to enforce because they are typically responsive in nature. Therefore, drivers who have become accustomed to using a mobile communication device while driving may be less likely to comply with a law that prohibits such use. This issue becomes more serious when drivers who are least able to multi-task, such as teenagers, the elderly, and inexperienced drivers, use a mobile communications device while driving.

Several ways to disable a mobile communications device have been introduced to prevent a person from simultaneously using a mobile communication device while driving a vehicle. For example, U.S. Pat. No. 7,856,203 issued to Lipovski, discloses a system for preventing a driver of a vehicle from using a cell phone to send or receive a text message while the vehicle is in motion. Lipovski teaches a series of steps that must be satisfied in order to disable a cell phone. One of these steps is whether the cell phone is near a driver's wheel. One disadvantage with such a method is that it relies on the position of a mobile communication device, which may cause the unintended result of disabling a device used by someone who is not driving the vehicle. Another disadvantage with this method is that a driver of a vehicle may use a mobile communication device this is far enough away from the steering wheel, so that the method is not satisfied and the driver's device is not disabled.

Consequently, a need exists for a method and system which can distinguish between an electronic device used by the driver of a vehicle and one used by a passenger. Further, a need exists for a method and system that can disable an electronic device used by the driver of a vehicle, regardless of the position of the driver's electronic device within the vehicle. In particular, a need exists for a method and system that can be used to disable select features of a mobile communication device used by the driver of a vehicle.

### SUMMARY

Disclosed herein is a system and method for controlling an electronic device. An electronic device may include, for example, a cell phone, smart phone, PDA, tablet computer, laptop computer, e-reader, and handheld video game.

One object of the present disclosure is a low power electric field coupled technology able to transmit a time-varying encoded signal having a frequency that can be redistributed across the human body. An encoded signal may be emitted from an electrode that is driven with a time-varying potential. Current flows from the electrode to a target that can redistribute charges at a particular frequency. A sensor measures the amount of current that flows from the electrode, which depends on the amount of coupling between the electrode and any targets that can redistribute the charges having a particular frequency. The amount of coupling depends on the interface area of the targets, and the gap between the electrode and any targets. The time-varying signal may be encoded with information using a variety of techniques (i.e., AM or FM).

According to this object, a human body can redistribute charges easily at the particular frequency of the signal, and the gap between the human and a sensing electrode is small enough to allow coupling between the sensing electrode and the human. Due to the low frequency and low power of the encoded signal, no appreciable signal is transmitted directly from the human into the air. An electronic device in proximity with a coupling target may be configured to detect the encoded signal. When an electronic device detects the encoded signal, the device may be controlled depending on the encoded information in the signal, which may be based on a condition of the vehicle (i.e., moving, in gear, deployment of an air bag). Advantageously, this system controls the use of an electronic device that is in the possession of an occupant of the vehicle (e.g., the driver). The device may be possessed in any number of ways such as, for example, held in hand, in a pocket, located in a receptacle/holder that typically used by the occupant. The system also controls one device, while not controlling the use of an electronic device in the hand of another passenger. In other words, only the use of an electronic device possessed by the driver is controlled.

Another object of the present disclosure is a method for controlling an electronic device. The occupancy or physical presence of a person is detected. Based on the detection of a person, an encoded signal is transmitted through the person. The signal is detected by an electronic device coupled to the person, and a response of the electronic device to the signal controls the electronic device by controlling one or features of the device.

A system and method for controlling an electronic device may permit the hands-free operation of the electronic device. For example, the encoded signal may provide a response in the electronic device so that if an electronic device is configured to allow hands-free operation, then the electronic device is able to respond to voice commands. However, the device would be controlled so that it would not respond when the person pushes buttons or touches a screen of the device.

A system and method for controlling an electronic device may allow an automated response to an encoded signal. For example, when a vehicle is in an emergency state, the sensing electrode may provide an encoded signal used to generate an automated response of the electronic device (i.e., make an emergency 911 call). Also, during normal operation of a vehicle, an electronic device in proximity to an encoded signal may respond by enabling a “blocking” mode. An electronic device with “blocking” mode enabled may auto-respond to incoming phone calls, text messages, or data requests.

An electronic device may alternatively transmit a signal after detecting an encoded signal from a sensing electrode. The sensing electrode may detect the signal from the electronic device and use it to modify a vehicle state. For example, a signal transmitted by the electronic device may be used to display an icon in the instrument panel that phone controls have been disabled. A signal may also be used to initiate a vehicle's Bluetooth or other hands-free system for hands-free operation of the electronic device.

It should be noted that certain occupant detection systems are able to detect the presence of a passenger in a front seat, and may emit a signal similar to a signal that would be used to control an electronic device. A signal used to control an electronic device may include digital information in order to distinguish it from similar signals. This would reduce the likelihood that an electronic device would deactivate or turn off when it detects the signal of interest.

In a preferred embodiment, the frequency of the encoded signal is approximately 70 KHz; however, any frequency that is strong enough to be transmitted through a person, but not so strong as to be appreciably transmitted into the air surrounding the person is suitable. Therefore, this disclosure is not intended to limit or define the frequency or power of a signal used to control an electronic device.

In other embodiments, the sensing electrode is located in any place in close proximity to the driver, such as through a seat belt, or the steering wheel. A vehicle seat, however, does take advantage of existing technology.

In an alternative embodiment for a system and method to control an electronic device, the electronic device emits a low power signal which is transmitted to a receiver via electric field coupling. Upon receiving a signal from an electronic device, the receiver may transmit a signal to the device in order to disable or control it. The receiver may transmit a signal to the device through various means, including Bluetooth, electric field coupling, Wi-Fi, or any other type of electronic communication.

In another embodiment of the disclosure, various conditions may override the system and method to control an electronic device. For example, if a sensor detects an emergency condition (i.e., vehicle rollover or crash), the sensing electrode may not transmit a coded signal to control an electronic device, or the electrode may transmit a coded signal that allows an electronic device to perform certain features. Further, in various embodiments of the present disclosure, some features of an electronic device that would normally be controlled by a system might have exceptions. For example, a system may normally prevent a cell phone in the hand of a person driving a vehicle from sending a text message; however, an exception may be made for emergency messages.

It should be noted that a system or method to control an electronic device may depend on manufacturers designing devices that will receive a signal that is transmitted through electric field coupling, and also respond to the signal so that various features of the device are controlled. For example, in order to effectively deter a person driving a vehicle from using a cell phone to send a text message, and thereby reduce the risk of the driver getting into an accident, the various manufacturers of cell phones may form a consortium so every cell phone can be controlled via electric field coupling. Current electronic devices, such as cell phones, may detect signals delivered via electric field coupling through low level software changes, or through minor hardware modifications to existing electronics, antenna, and transceiver circuits. Also, regulatory agencies may develop a standard for automotive or cell phone technologies so that electronic devices may be controlled through electric field coupling.

It is to be understood that both the foregoing general description and the following detailed description are exemplary and explanatory only, and are not restrictive of the invention as claimed.

### BRIEF DESCRIPTION OF THF; DRAWINGS

These and other features, aspects, and advantages of the present invention will become apparent from the following description, appended claims, and the accompanying exemplary embodiments shown in the drawings, which are briefly described below.

FIG. 1 is a perspective view of a system used to control an electronic device according to an embodiment of the disclosure.

FIG. 2 is a schematic view of a method used to control an electronic device according to an embodiment of the disclosure.

### DETAILED DESCRIPTION

Embodiments of the present invention will be described below with reference to the drawings.

Several systems and methods are proposed to control an electronic device. According to one embodiment for a system 70 used to control an electronic device 30, a sensor (not shown) can detect occupancy of a person, and a sensing electrode 10 provides a time-varying encoded signal 20 in response to the sensor's detection. A sensor used to detect occupancy of a person can be any type of sensor, such as a proximity sensor, optical sensor, pressure sensor, capacitive or electric field sensor, touch sensor, and any other sensor that may determine the physical presence of an object. Encoded signal 20 has a particular frequency and power, and may include information, such as digital information, to distinguish it from similar signals. Encoded signal 20 is emitted from sensing electrode 10 which is driven with a time-varying potential. Current flows from the sensing electrode 10 to a target that can redistribute charges at the frequency of encoded signal 20. An exemplary occupant sensing system that could be employed with the system described herein is disclosed in U.S. Pat. Nos. 6,392,542 and 7,180,306 (both incorporated by reference herein in their entireties). The systems disclosed in these patents include a sensing electrode positioned in proximity to an occupant of a vehicle seat.

The frequency of encoded signal 20 is configured so a human body can redistribute the charges of the signal easily. Sensing electrode 10 is configured to transmit encoded signal 20 through a person via capacitive or electric field coupling. The amount of electric field coupling between sensing electrode 10 and a person depends on the interface area of the person, and the gap distance between the electrode 10 and the person. The frequency and power of signal 20 is strong enough to be transmitted through a person, but not so strong as to be appreciably transmitted into the air surrounding the person. An electronic device 30 that is touched by the person, or proximately close to the person (i.e., in a pocket of the person's clothes, or on the person's lap), can detect signal 20 through electric field coupling (e.g. capacitive, inductive). An electronic device 30 may include any type of device that is handheld, portable, or interactive, such as a cell phone, PDA, smartphone, MP3 player, tablet computer, laptop computer, computer display, touchscreen display, and video game system. When the electronic device 30 detects the signal 20, its response to signal 20 is controlling a feature of electronic device 30.

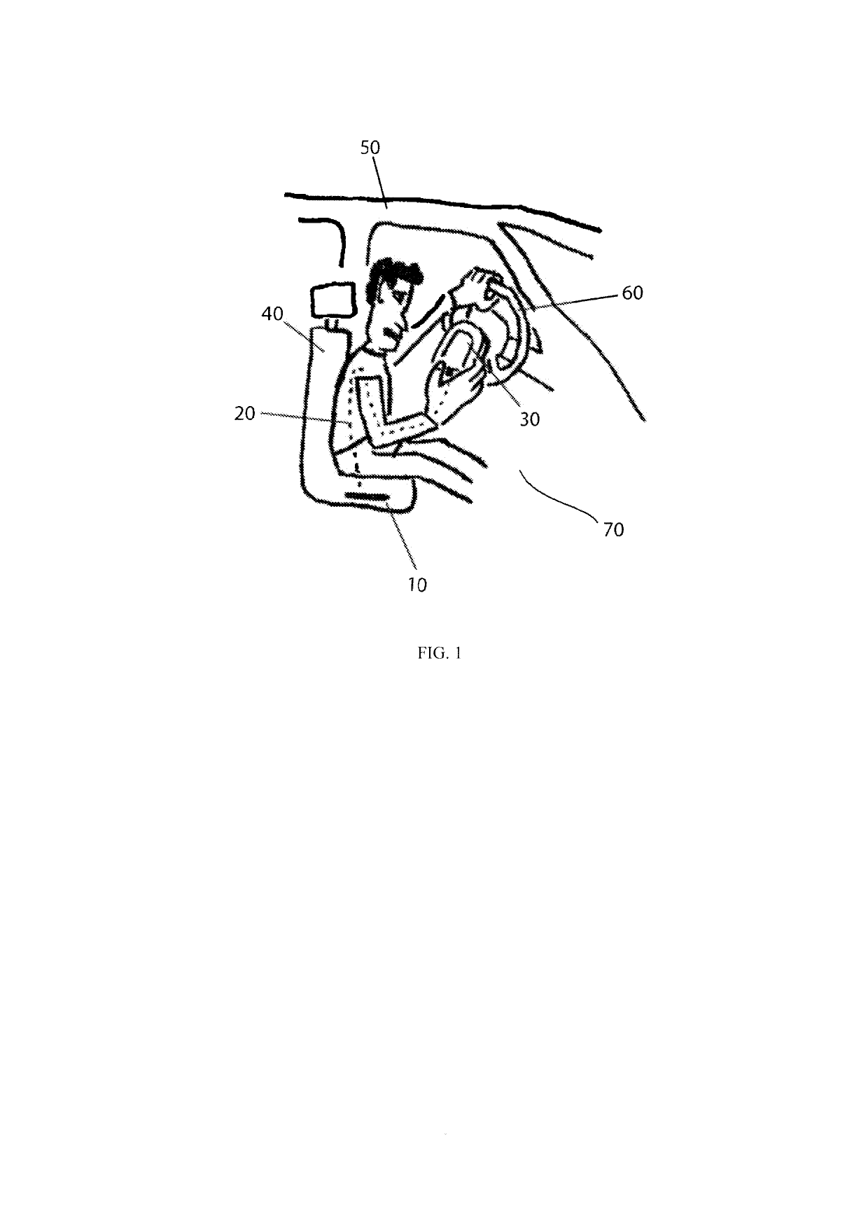

As shown in FIG. 1, the sensing electrode 10 for a system 70 to control an electronic device 30 may be located in the driver's seat 40 of a vehicle 50. A vehicle may include a passenger vehicle, commercial vehicle, bus, motorcycle, train, boat, airplane, piece of construction equipment, or any other type of vehicle that is driven or operated by a person. The sensor detects the occupancy of a person sitting in the driver's seat 40. Control electronics (not shown) may obtain vehicle speed information and provide this information to the sensing electrode 10. If the vehicle speed information shows the vehicle as moving, the sensing electrode 10 may transmit an encoded signal 20 to a target that can redistribute charges at the frequency of signal 20. Encoded signal 20 is configured so a human body can redistribute the charges of the signal easily. Therefore, when sensing electrode 10 located in a driver's seat transmits encoded signal 20, the person sitting in the driver's seat redistributes the charges of signal 20. An electronic device 30 touched by the driver, or positioned proximately close to the driver (e.g., in a pocket of the clothes, on the person's lap, in a close receptacle or holder), such as a cell phone in the driver's hand, detects signal 20 transmitted through the driver. A response of the electronic device 30 to signal 20 is the control of a feature of electronic device 30. For example, electronic device 30 may respond to signal 20 by disabling features that allow a user to send or receive text messages or data messages.

According to an alternative embodiment, an electronic device 30 may alternatively transmit a signal after detecting an encoded signal 20 from a sensing electrode 10. The sensing electrode 10 may detect the signal from the electronic device 30 and use it to modify a vehicle state. For example, a signal transmitted by the electronic device 30 may be used to display an icon in the instrument panel of the vehicle 50 to indicate that phone controls have been disabled. A signal may also be used to initiate a vehicle's Bluetooth or other hands-free system for hands-free operation of the electronic device.

According to another embodiment, signal 20 may be coded to control features belonging to certain makes, models, and types of electronic devices. Also, certain types of devices may not be configured to respond to signal 20. For example, signal 20 might not be configured to control a “hands-free” device, such as a Bluetooth headset for a cell phone. Also, a cell phone may be allowed to cooperatively operate with a hands-free device in response to detecting signal 20.

Exceptions may exist for how a system or method is used to control an electronic device. Special circumstances (i.e., a vehicle accident or rollover) may override or prevent sensing electrode 10 from transmitting signal 20. Also, there may be exceptions for the response of an electronic device to signal 20. For example, signal 20 may normally be coded to disable features that allow a cell phone to place phone calls; however, an exception may be made for emergency or 911 phone calls.

Another embodiment for a system to control an electronic device may include a sensing pad located on an unoccupied seat, or other exposed surface, such as an arm rest, cup holder, dashboard, or center console. The sensing pad may transmit a signal that is received by the electronic device, and a response of the device to the signal is the control for a feature of the device. Some responses may include disabling of certain features, or enabling hands-free technology.

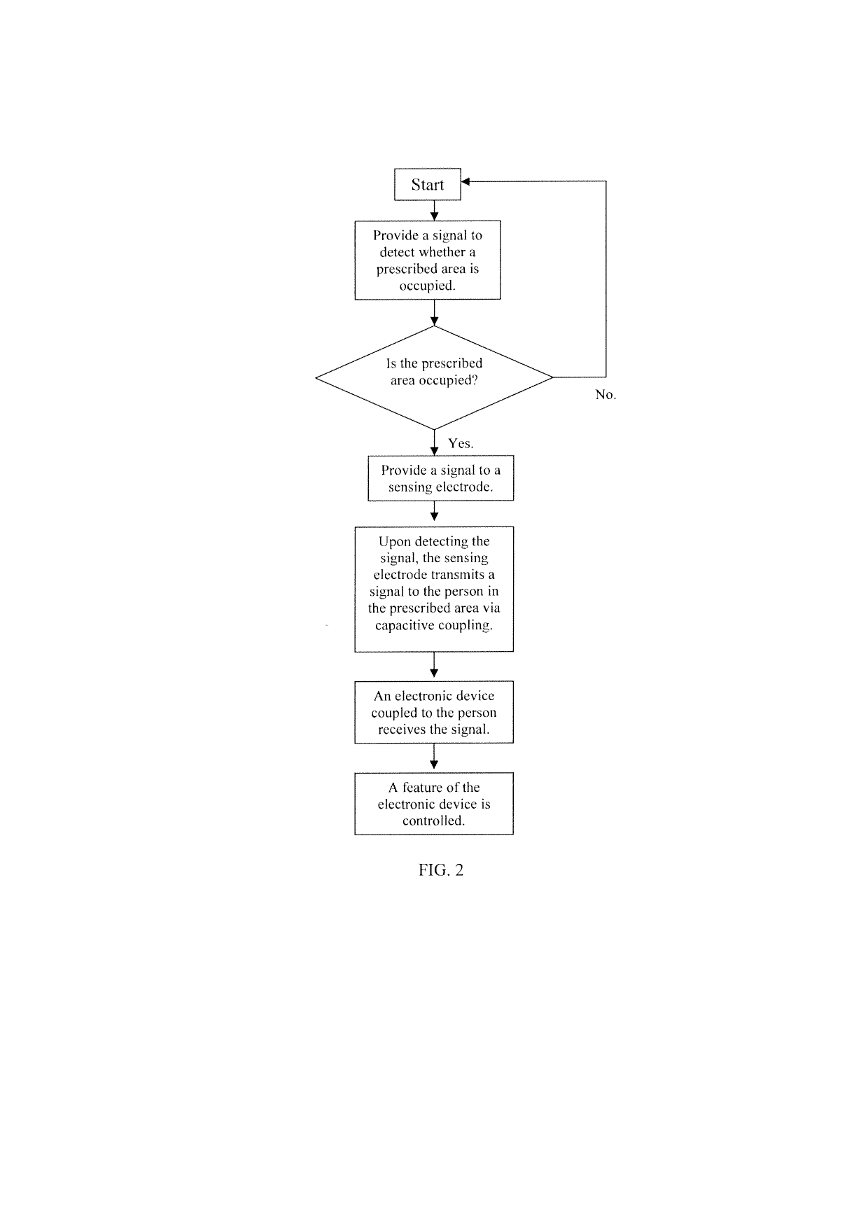

According to another embodiment of the disclosure, and as shown in FIG. 2, a method is provided to control an electronic device. Such a method may detect whether a prescribed space is occupied by a person. If so, a signal may be transmitted through the person via electric field coupling. The signal may be detected by an electronic device coupled to the person, and a response of the device to the signal may be to control a feature of the device.

Although specific shapes and locations of each element have been set forth in the drawings, each element may be of any other shape or location that facilitates the function to be performed by that element. For example, the cameras and light sources have been shown in particular vehicle locations; however, in other exemplary embodiments the sensing elements may be located anywhere in the vehicle.

For purposes of this disclosure, the term “coupled” means the joining of two components (electrical, mechanical, or magnetic) directly or indirectly to one another. Such joining may be stationary in nature or movable in nature. Such joining may be achieved with the two components (electrical or mechanical) and any additional intermediate members being integrally defined as a single unitary body with one another or with the two components or the two components and any additional member being attached to one another. Such joining may be permanent in nature or alternatively may be removable or releasable in nature.

The present disclosure has been described with reference to example embodiments, however persons skilled in the art will recognize that changes may be made in form and detail without departing from the spirit and scope of the disclosed subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the exemplary embodiments is manifestly intended to be as broad as possible. For example, unless specifically otherwise noted, the exemplary embodiments reciting a single particular element also encompass a plurality of such particular elements.

Exemplary embodiments may include program products comprising computer or machine-readable media for carrying or having machine-executable instructions or data structures stored thereon. For example, the sensing electrode may be computer driven. Exemplary embodiments illustrated in the methods of the figures may be controlled by program products comprising computer or machine-readable media for carrying or having machine-executable instructions or data structures stored thereon. Such computer or machine-readable media can be any available media which can be accessed by a general purpose or special purpose computer or other machine with a processor. By way of example, such computer or machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of computer or machine-readable media. Computer or machine-executable instructions comprise, for example, instructions and data which cause a general purpose computer, special purpose computer, or special purpose processing machines to perform a certain function or group of functions. Software implementations of the present disclosure could be accomplished with standard programming techniques with rule based logic and other logic to accomplish the various connection steps, processing steps, comparison steps and decision steps.

It is also important to note that the construction and arrangement of the elements of the system as shown in the preferred and other exemplary embodiments is illustrative only. Although only a certain number of embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the assemblies may be reversed or otherwise varied, the length or width of the structures and/or members or connectors or other elements of the system may be varied, the nature or number of adjustment or attachment positions provided between the elements may be varied. It should be noted that the elements and/or assemblies of the system may be constructed from any of a wide variety of materials that provide sufficient strength or durability. Accordingly, all such modifications are intended to be included within the scope of the present disclosure. The order or sequence of any process or method steps may be varied or re-sequenced according to alternative embodiments. Other substitutions, modifications, changes and omissions may be made in the design, operating conditions and arrangement of the preferred and other exemplary embodiments without departing from the spirit of the present subject matter.

What is claimed is:

1. A system for controlling an electronic device, comprising:
a sensor configured to detect occupancy of a person;
a sensing electrode that provides a signal in response to the sensor, the signal having a particular frequency and power;
wherein the electrode is configured to transmit the signal to the person detected by the sensor;
wherein an electronic device is configured to detect the signal when the electronic device is coupled to the person; and
wherein a first response of the electronic device to the signal is controlling a feature of the electronic device.

2. The system of claim 1, wherein the frequency of the signal is configured to allow the signal to be redistributed through the person; and
wherein the signal is not strong enough to be transmitted to the air surrounding the person.

3. The system of claim 2, wherein the sensing electrode is located within one of a seat, a steering wheel, and a seat belt of a vehicle.

4. The system of claim 3, wherein the signal is encoded with information to provide for a particular response of the electronic device based on a state of the vehicle.

5. The system of claim 4, wherein a second response of the electronic device to the encoded signal is transmitting a signal used to modify a state of the vehicle.

6. The system of claim 5, wherein the electronic device is a cell phone.

7. The system of claim 6, wherein when the vehicle is in one of a non-moving and emergency state, the sensing electrode does not transmit an encoded signal.

8. The system of claim 6, wherein when the vehicle is in an emergency state, the sensing electrode transmits a signal having encoded information used to generate an automated response of the electronic device.

9. A method for controlling an electronic device using electric field coupling, comprising the following steps:
detecting the occupancy of a person;
transmitting an electronic signal from a sensing electrode to an electronic device, using the person as a conduit;
wherein the electronic signal is not strong enough to be transmitted to the air surrounding the person;
wherein a response of the electronic device to the signal is controlling a feature of the electronic device.

10. The method of claim 9, wherein the sensing electrode is located within one of a seat, a steering wheel, and a seat belt of a vehicle.

11. The method of claim 10, wherein the person is driving a vehicle.

12. The method of claim 11, wherein the sensing electrode does not transmit an electronic signal to the electronic device in certain circumstances, including emergencies.

13. A method for controlling an electronic device using electric field coupling, comprising the following steps:
detecting the occupancy of a person;
transmitting an electronic signal from a sensing electrode to a person by electric field coupling;
wherein the electronic signal is not strong enough to be transmitted to the air surrounding the person;
wherein an electronic device is configured to detect the signal transmitted to the person when the electronic device is coupled to the person; and
wherein a response of the electronic device to the signal is controlling a feature of the electronic device.

14. The method of claim 13, wherein the sensing electrode is located within one of a seat, a steering wheel, and a seat belt of a vehicle.

15. A system for controlling an electronic device using electric field coupling, comprising:
an electrode that provides a signal having a particular frequency configured to allow the signal to be redistributed through a person;
a sensor configured to measure the amount of current flowing out of the electrode;
wherein the signal is not strong enough to be transmitted to the air surrounding the person;
wherein an electronic device is configured to detect the signal when the electronic device is coupled to the person; and
wherein a first response of the electronic device to the signal is controlling a feature of the electronic device.

16. The system of claim 15, wherein the sensing electrode is located within one of a seat, a steering wheel, and a seat belt of a vehicle.

17. The system of claim 16, wherein the signal is encoded with information to provide for a particular response of the electronic device based on a state of the vehicle.

18. The system of claim 17, wherein a second response of the electronic device to the encoded signal is transmitting a signal used to modify a state of the vehicle.

19. The system of claim 18, wherein the electronic device is a cell phone.

20. The system of claim 19, wherein when the vehicle is in one of a non-moving and emergency state, the sensing electrode does not transmit an encoded signal.

21. The system of claim 20, wherein when the vehicle is in an emergency state, the sensing electrode transmits a signal having encoded information used to generate an automated response of the electronic device.
